(19) United States
(12) Patent Application Publication
(10) Pub. No.: US 2014/0137400 A1
(43) Pub. Date: May 22, 2014

(54) METHOD OF PRODUCING SILICON MATERIAL, ANODE MATERIAL AND METHOD OF PRODUCING ANODE ELECTRODE OF LITHIUM-ION BATTERY

(71) Applicant: QUAN AN RESOURCE CO., LTD., Taoyuan County (TW)

(72) Inventors: Tung-Ko Cheng, New Taipei City (TW); Li-Yin Hsiao, Tainan City (TW)

(73) Assignee: QUAN AN RESOURCE CO., LTD., Taoyuan County (TW)

(21) Appl. No.: 13/832,711

(22) Filed: Mar. 15, 2013

(30) Foreign Application Priority Data
Nov. 16, 2012 (TW) 101142793

(51) Int. Cl. C01B 33/02; H01M 4/04; B02C 18/00

(52) U.S. Cl. CPC C01B 33/02; B02C 18/00; H01M 4/0404
USPC 29/623.5; 241/24.11; 428/402

(57) ABSTRACT

Provided is a method of producing a silicon material, comprising: slicing a silicon substrate with a fixed-abrasives wire to obtain a mixing slurry; and treating the mixing slurry by solid-liquid separation, so as to isolate a silicon material from the mixing slurry, which is applicable for a lithium-ion battery. With the simplified method, the production cost of silicon material is remarkably reduced. Furthermore, an anode material of a lithium-ion battery and a method of producing an anode electrode of a lithium-ion battery are provided. Since the silicon material produced by the method has high purity and fine granules, the extreme volumetric expansion of silicon under heat is largely reduced, and thus the cycle stability, electrical performance, and quality of a lithium-ion battery comprising the silicon material are improved.

### CROSS-REFERENCE TO RELATED APPLICATION

Pursuant to 35 U.S.C. §119(a), this application claims the benefit of the priority to Taiwan Patent Application No. 101142793, filed Nov. 16, 2012. The content of the prior application is incorporated herein by its entirety.

### BACKGROUND OF THE INVENTION

1. Field of the Invention

The present invention relates to a method of producing a silicon material and its application, more particularly to a method of slicing a silicon substrate with a wire sawing tool to produce the silicon material with high purity. In addition, the present invention also relates to an anode material of a lithium-ion battery and a method of producing an anode electrode of a lithium-ion battery.

2. Description of the Prior Arts

With advantages such as low electrode potential, high efficiency, and long cycle life, lithium-ion batteries have been widely applied in high-tech products, including mobiles and notebooks, and electric vehicles.

Conventional lithium-ion batteries generally comprise carbon-based materials as the anode material in view of safety requirement. Commonly used carbon-based materials include natural graphite, artificial graphite, and mesophase asphalts. However, the conventional lithium-ion batteries only have a theory capacity about 372 mAh/g, inadequate for application on high-tech products or long-distance electric-vehicles of the up-to-date demand.

In order to meet the high capacity demands, use of silicon as a principal anode material is developed for enhancing theory capacity of a lithium-ion battery up to about 4400 mAh/g.

However, an anode material of a lithium-ion battery comprising silicon still has several problems. For example, silicon has smaller density if forming a lithium-silicon alloy with lithium ions, and therefore it usually expands to almost 300% to 400% of its original volume during charge and discharge processes. As a result, such extreme but unavoidable volumetric expansion destroys the anode electrode and shortens the cycle life of the lithium-ion battery. Moreover, a lithium-ion battery with high capacity further produces abundant heat while charging and discharging, and thus can hardly provide desired cycle stability, electrical performance and quality.

To overcome the aforementioned problems and to produce a lithium-ion battery with desired capacity and cycle life, a silicon material with fine particles is used to avoid the volumetric expansion and anode break. In addition, inactive materials are also doped into the silicon material to supply thermal conductivity, thereby providing the lithium-ion battery with improved cycle stability, electrical performance, and quality.

However, conventional methods, including chemical vapor deposition for making a silicon film, high energy ball milling or chemical synthesis for making silicon nanoparticles are too expensive for mass production, such that silicon materials still cannot replace conventional carbon-based materials and cannot be widely used for producing an anode material of a lithium-ion battery.

Based on the aforementioned problems, a method of producing a silicon material capable for mass production is much needed to improve its application for making a lithium-ion battery.

### SUMMARY OF THE INVENTION

In view that manufacturing a silicon material by chemical vapor deposition, high energy ball milling and chemical synthesis has disadvantages such as high cost and low quality, the first objective of the present invention is to provide a method of producing a large amount of silicon material of high purity and having fine granules, thereby producing a silicon material particularly applicable for an anode electrode of a lithium-ion battery.

To achieve the objective, the present invention provides a method of producing a silicon material, comprising the steps of:

providing a wire sawing tool comprising a cutting wire, a base layer disposed on the cutting wire, and multiple abrasives partially embedded into the base layer and having particle sizes ranging from 1 micrometer to 100 micrometers;

slicing a silicon substrate with the wire sawing tool to obtain a mixing slurry, the mixing slurry comprises silicon granules, a few abrasive granules and a few cutting wire granules; and

treating the mixing slurry by solid-liquid separation, so as to isolate the silicon material from the mixing slurry.

Accordingly, the present invention successfully provides a simplified method for mass production of silicon material. By slicing a silicon substrate with abrasives having predetermined particle sizes and a cutting wire with a predetermined diameter, a large amount of silicon granules with determined particle sizes are produced. As a result, the method is beneficial for mass production of silicon material, which can be applied to an anode electrode of a lithium-ion battery, thereby significantly reducing production cost and processing complexity.

In accordance with the present invention, the wire sawing tool is directed to a tool with fixed-abrasives wire.

In accordance with the present invention, the abrasives are partially embedded into the base layer and has a working surface exposed from the base layer. When the cutting wire is operated by driving rollers to slice the silicon substrate, the abrasives of the rapidly-moved cutting wire contact both an edge of the cutting wire and the surface of the silicon substrate, thereby disposed between the cutting wire and the silicon substrate for grinding the silicon substrate to obtain a large amount of silicon granules during slicing.

The step of slicing a silicon substrate with a wire sawing tool preferably comprises supplying a coolant onto the silicon substrate while slicing the silicon substrate with a wire sawing tool, such that the edge of the cutting wire and the surface of the silicon substrate is cooled. Accordingly, a silicon material produced by the method is favorable for making a lithium-ion battery with stability and good quality.

In accordance with the present invention, said coolant is generally water-soluble. The coolant comprises, but not limited to, water, diethylene glycol or propylene glycol.

In accordance with the present invention, said “mixing slurry” is collected from the step of slicing a silicon substrate with a wire sawing tool, which comprises silicon granules from the silicon substrate, cutting wire granules from the cutting wire of the wire sawing tool, abrasive granules from the abrasives of the wire sawing tool, remainder from the base layer, and remainder from the coolant or their combinations. A total amount of the cutting wire granules, abrasive granules and remainder from the base layer are not more than 5.00 percentage by weight (wt %) based on a total amount of the mixing slurry.

In accordance with the present invention, the abrasives are made of the group consisting of: diamond, diamond-like carbon, silicon carbide, boron carbide, aluminum nitride, zirconium dioxide and their combinations.

In accordance with the present invention, the base layer is made of resin, metal, or metal alloy. For instance, the abrasives are attached onto a metal or metal alloy layer by electroplating.

In accordance with the present invention, the silicon substrate comprises single crystal silicon substrate, polycrystalline silicon substrate or amorphous silicon substrate. The silicon substrate may be, for example, but not limited to, silicon rod, silicon ingot or silicon brick. The silicon substrate may be further doped with at least one element selected from the group consisting of: boron, phosphorus, arsenic, antimony, aluminum, germanium, and indium. Preferably, an amount of the at least one element relative to the amount of the silicon substrate ranges from 0.0001 to 0.1 percentage by weight (wt %). Preferably, an amount of the at least one element relative to the volume of the silicon substrate ranges from 10¹³ to 10¹⁵ atoms/cm³.

In accordance with the present invention, a mixing slurry containing granules with predetermined particle sizes can be produced by using abrasives with controlled particle sizes and using a cutting wire with a predetermined diameter. Preferably, the abrasives have particle sizes ranging from 1 micrometer to 50 micrometers, and thus the mixing slurry generated by slicing a silicon substrate with said wire sawing tool contains granules less than 10 micrometers.

Preferably, the cutting wire has a diameter ranging from 80 micrometers to 500 micrometers; more preferably, the cutting wire has a diameter ranging from 80 micrometers to 200 micrometers.

Accordingly, the silicon material comprises 95.00 wt % to 99.99 wt % of silicon granules and 0.01 wt % to 5.00 wt % of abrasive granules.

Preferably, the silicon material has particle sizes ranging from 5 nanometers (nm) to 10 micrometers (μm). More preferably, the silicon material has particle sizes ranging from 5 nanometers to 2 micrometers. Said particle sizes of the silicon material are directed to particle sizes of primary particles before aggregation, and also to particle sizes of secondary particles after aggregation.

Preferably, the step of treating the mixing slurry by solid-liquid separation, so as to isolate the silicon material from the mixing slurry comprises: separating the mixing slurry into a liquid mixture and a solid mixture by solid-liquid separation; washing the solid mixture with an aqueous solution to form a washed mixture; and treating the washed mixture by solid-liquid separation, so as to isolate the silicon material from the washed mixture. Accordingly the coolant contained in the mixing slurry is removed by the washing steps, avoiding the coolant adhering to the surface of silicon granules of the silicon material, and thereby improving the electrical performance and quality of a lithium-ion battery containing the silicon material.

Said aqueous solution may be pure water, water-containing solution, solution collected from washing steps or their combinations.

Preferably, the metal, metal alloy or their oxides contained in the solid mixture or washed mixture is/are further removed by either acidic-washing or magnetic separation before or after washing the solid mixture with an aqueous solution.

In accordance with the present invention, both the cutting wire and cutting wire granules are made of iron, copper, nickel, their alloy or their combinations.

In accordance with the present invention, the method also comprises washing the solid mixture with at least one acidic solution, such as sulfuric acid, hydrochloric acid or nitric acid, to remove the cutting wire granules from the solid mixture. Herein, the material of the cutting wire granules capable of dissolving by the acidic solution and then removing by the aforementioned step is iron, copper, nickel or their combinations. The material of the cutting wire granules capable of being removed by magnetic separation is iron, nickel or their combinations. Both methods improve the purity of the silicon material.

In accordance with the present invention, said two steps for removing the cutting wire granules from the solid mixture can be independently performed or in corporation with the other, and the precedence of the two steps is not particularly limited.

Preferably, the step of treating the mixing slurry by solid-liquid separation, so as to isolate the silicon material from the mixing slurry comprises: separating the mixing slurry into a liquid mixture and a solid mixture by solid-liquid separation; washing the solid mixture with an acidic solution to remove iron, copper, nickel or their combinations remaining in the solid mixture, so as to form a purified mixture; and treating the purified mixture by solid-liquid separation, so as to isolate the silicon material from the purified mixture.

Preferably, the step of treating the mixing slurry by solid-liquid separation, so as to isolate the silicon material from the mixing slurry comprises: separating the mixing slurry into a liquid mixture and a solid mixture by solid-liquid separation; and removing iron, nickel or their combinations from the solid mixture by magnetic separation, so as to obtain the silicon material; or the step comprises: removing iron, nickel or their combinations from the mixing slurry by magnetic separation to form a collected mixture; and treating the collected mixture by solid-liquid separation, so as to isolate the silicon material from the collected mixture.

Preferably, the step of treating the mixing slurry by solid-liquid separation, so as to isolate the silicon material from the mixing slurry comprises: separating the mixing slurry into a liquid mixture and a solid mixture by solid-liquid separation; removing iron, nickel or their combinations from the solid mixture by magnetic separation to obtain a collected mixture; and treating the collected mixture by solid-liquid separation, so as to isolate the silicon material from the collected mixture.

Preferably, the method of the present invention further comprises drying the silicon material to obtain a powdered silicon material, such that the coolant remaining on the surface of silicon granules can be effectively removed, improving the quality of the silicon material applied as an anode material of a lithium-ion battery. Preferably, the silicon material is dried at a temperature ranging from 80° C. to 120° C. Preferably, the powdered silicon material has particle sizes ranging from 5 nanometers to 10 micrometers.

Preferably, the solid-liquid separation includes centrifuge separation, filter-pressing separation, sedimentation, membrane filtration, or decantation separation.

In accordance with the present invention, the silicon material mainly comprises silicon granules and abrasive granules. Preferably, the silicon material produced by the method has a purity of silicon not less than 95%, and more preferably not less than 99%.

The second objective of the present invention is to provide an anode material with high purity of silicon, which is also applicable for producing a lithium-ion battery without extreme volumetric expansion when charging and discharging thereof.

To achieve the objective, the present invention provides an anode material of a lithium-ion battery, comprising a silicon material produced by the method described above, wherein the silicon material has particle sizes ranging from 5 nanometers to 10 micrometers.

Preferably, the silicon material mainly comprises silicon granules and further has a few abrasive granules. On the basis of the total weight of the silicon material, an amount of the silicon granules ranges from 95.00 wt % to 99.99 wt %, and an amount of the abrasive granules ranges from 0.01 to 5.00 wt %.

Preferably, the anode material of the lithium-ion battery further comprises a carbonaceous material and a binder. The carbonaceous material may be: conductive graphite, e.g., SFG-6, SFG-15, KS-6, KS-15, all manufactured by TIMCAL Ltd.; conductive carbon black, e.g., TIMREX® Ensaco 350G; vapor grown carbon nanofibers (VGCF); carbon nanotubes (CNTs); Ketjenblack, e.g., Ketjenblack EC300J, Ketjenblack EC600JD, Carbon ECP, Carbon ECP600JD, SUPER-P, all manufactured by Lion Coporation, or their combinations. The binder may be: polyvinylidene difluoride (PVDF), N-methylpyrrolidone (NMP), carboxymethyl cellulose sodium (CMC), styrene-butadiene rubber (SBR), polyimide or their combinations.

The third objective of the present invention is to provide a method of producing an anode electrode of a lithium-ion battery, which can reduce the production cost and further improve the capacity stability and electrical performance during multiple cycles.

To achieve the objective, the present invention provides a method of producing an anode electrode of a lithium-ion battery, comprising the steps of:

preparing a silicon material produced by a method as described above, the silicon material has particle sizes ranging from 5 nanometers to 10 micrometers; mixing the silicon material with a carbonaceous material to form a slurry; and

coating the slurry on a metal substrate and drying the slurry, so as to produce the anode electrode of the lithium-ion battery.

Preferably, the step of preparing a silicon material comprises: providing a wire sawing tool comprising a cutting wire, a base layer disposed on the cutting wire, and multiple abrasives partially embedded into the base layer and having particle sizes ranging from 1 micrometer to 50 micrometers; slicing a silicon substrate with the wire sawing tool to obtain a mixing slurry; and treating the mixing slurry by solid-liquid separation, so as to isolate the silicon material from the mixing slurry.

To sum up, the present invention successfully provides a mass production method, comprising slicing a silicon substrate and undergoing suitable purifications with a few abrasives remaining in the silicon material, such that the extreme volumetric expansion of the silicon material under heat can be prevented, and producing a superior silicon material than that produced by the conventional methods. Consequently, the method in accordance with the present invention not only can produce a silicon material by low cost and simplified process, but also can provide a silicon material applicable for making a lithium-ion battery with improved cycle stability, electrical performance, and quality

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of the method of producing a silicon material of Examples 1-5 in accordance with the present invention;

FIGS. 2A and 2B illustrate a silicon substrate sliced by a wire sawing tool;

FIGS. 3A to 3E are respectively particle size distribution graphs of mixing slurries in Examples 1-5;

FIGS. 4A to 4C are respectively scanning electron microscope images of mixing slurries in Examples 1, 2 and 5;

FIGS. 5A and 5B are scanning electron microscope images of powdered silicon material in Example 1;

FIG. 6 is a particle size distribution graph of the powdered silicon material in Example 1;

FIG. 7 shows the capacity versus voltage of a lithium-ion battery in Example 6 after the first charge and discharge cycle;

FIG. 8 shows the capacity versus cycle numbers of a lithium-ion battery in Example 6 during the 1^{st} to 30^{th} charge/discharge cycles; and

FIG. 9 shows the columbic efficiency versus cycle numbers of a lithium-ion battery in Example 6 during 1^{st} to 30^{th} charge/discharge cycles.

### DETAILED DESCRIPTION OF THE PREFERRED EMBODIMENTS

Hereinafter, one skilled in the arts can easily realize the advantages and effects of a method of producing a silicon material and its application in accordance with the present invention from the following examples. Therefore, it should be understood that the descriptions proposed herein are just preferable examples only for the purpose of illustrations, not intended to limit the scope of the invention. Various modifications and variations could be made in order to practice or apply the present invention without departing from the spirit and scope of the invention.

### Examples 1-5

### Producing Silicon Materials

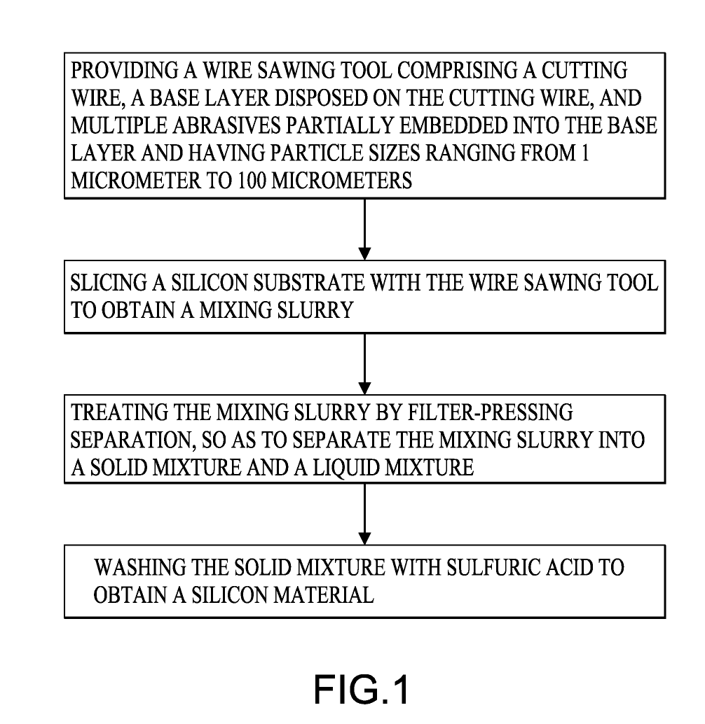

A method of producing a silicon material was implemented as described in detail incorporating the block diagram as shown in FIG. 1.

First, a silicon substrate and a wire sawing tool for slicing the silicon substrate were provided. The wire sawing tool comprised a cutting wire, a base layer and multiple abrasives. In the present examples, the cutting wire was made of iron and nickel and had a diameter ranging from 80 micrometers to 500 micrometers. The base layer was made of resin, and the abrasives were made of diamonds with particle sizes ranging from 1 micrometer to 100 micrometers. The silicon substrate was a single crystal silicon rod.

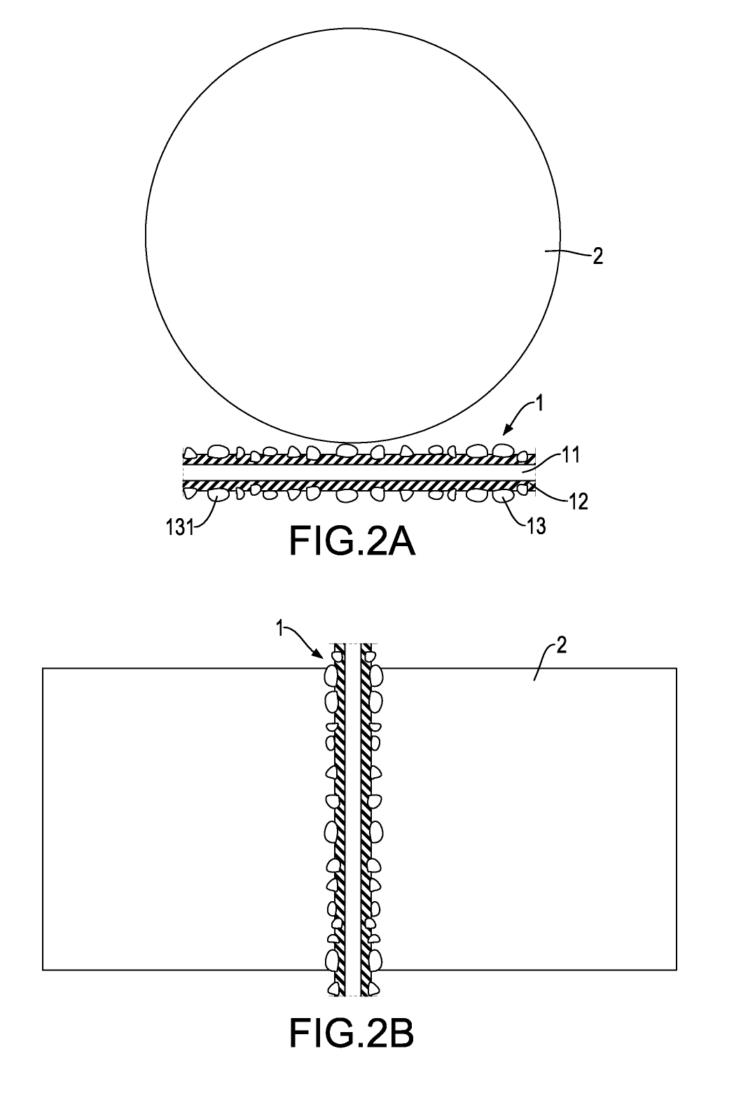

With reference to FIG. 2A, the base layer 12 was disposed on the cutting wire 11 of the wire sawing tool 1, and the abrasives 13 were partially embedded into the base layer 12 and had a working surface 131 exposed from the base layer 12.

Further referring to FIG. 2B, in addition to the wire sawing tool 1, a cutting fluid and a coolant (both not shown in the figure) were also used to slice a silicon substrate 2 to obtain a mixing slurry. Said mixing slurry comprised a mixed granule solids derived from the silicon substrate, cutting wire and abrasives, coolant and aqueous cutting fluid.

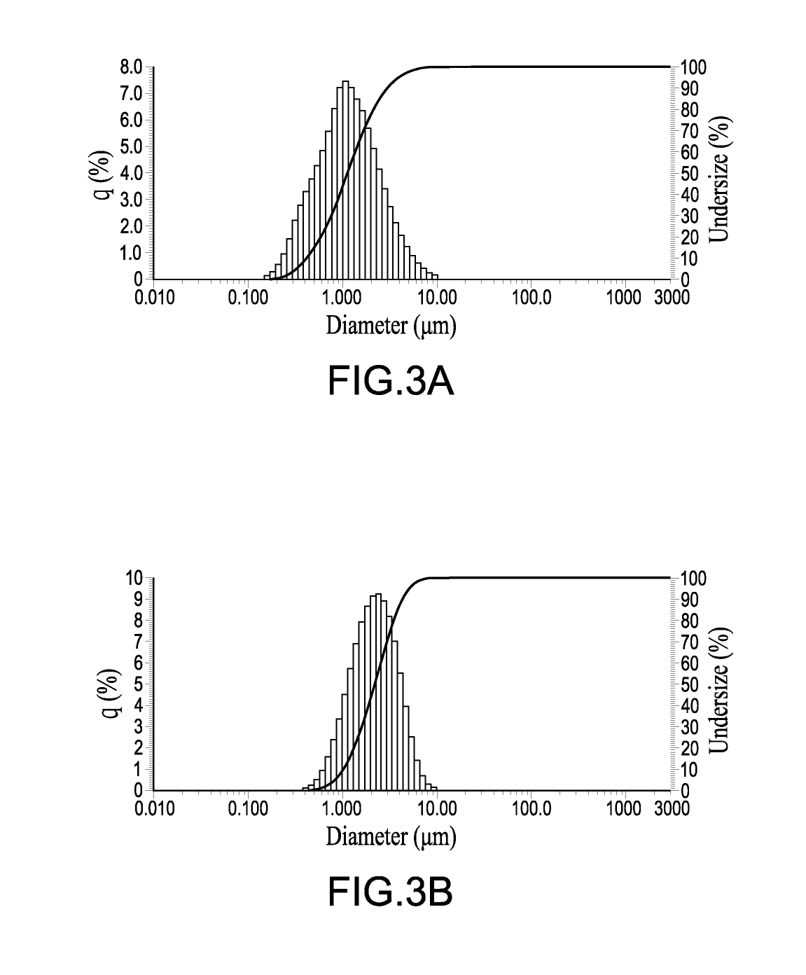

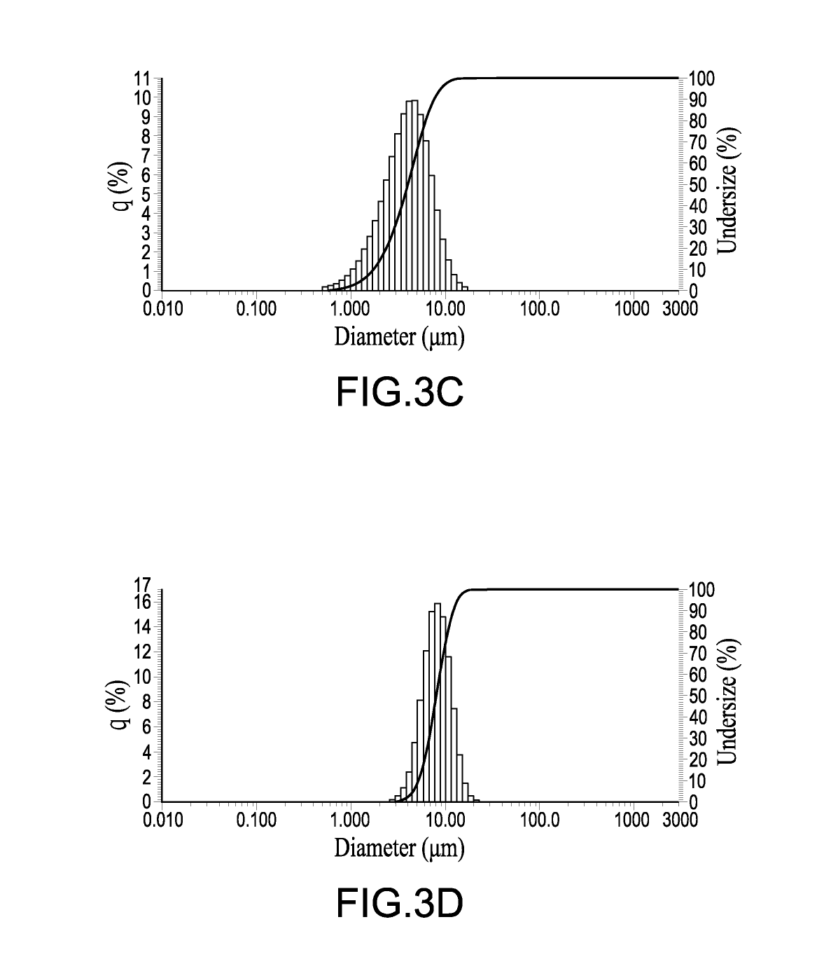

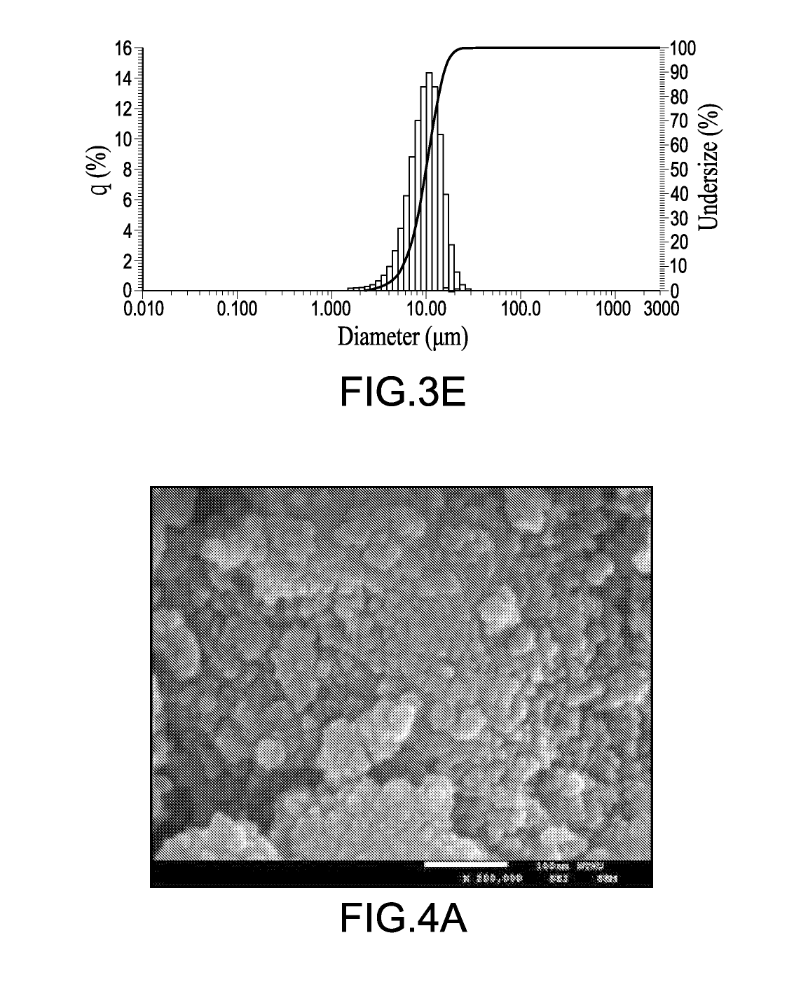

Since diameter of the cutting wire and particle sizes of the abrasives used in Example 1 were different from those in other Examples, five mixing slurries with different particle size distributions were therefore obtained in Examples 1-5. The diameter of the cutting wire, particle sizes of the abrasives and mean particle size of the solid mixture contained in the mixing slurry were listed in Table 1. The particle size distribution results in Examples 1-5 were also respectively shown in FIGS. 3A to 3E.

Said “mean particle size (D50)” is directed to a particle size at 50% in the cumulative distribution after arranged by particle size. The mean particle sizes as shown in Table 1 were determined by particle size distribution analyzer after the solid mixture of the mixing slurry had aggregated.

TABLE 1
the diameters of the cutting wires, the particle sizes of the abrasives
used to slice a silicon substrate and the mean particle sizes (D50)
of the secondary particles contained in the mixing slurries
generated in Examples 1-5

| | Diameter of | Particle size of | Mean particle size of solid |
|---|---|---|---|
| | cutting wire | abrasives | mixture in mixing slurry (D50) |
| Example 1 | 80 μm | 15 μm | 1.12 μm |
| Example 2 | 120 μm | 25 μm | 2.20 μm |
| Example 3 | 220 μm | 45 μm | 4.02 μm |
| Example 4 | 300 μm | 65 μm | 8.07 μm |
| Example 5 | 500 μm | 100 μm | 10.00 μm |

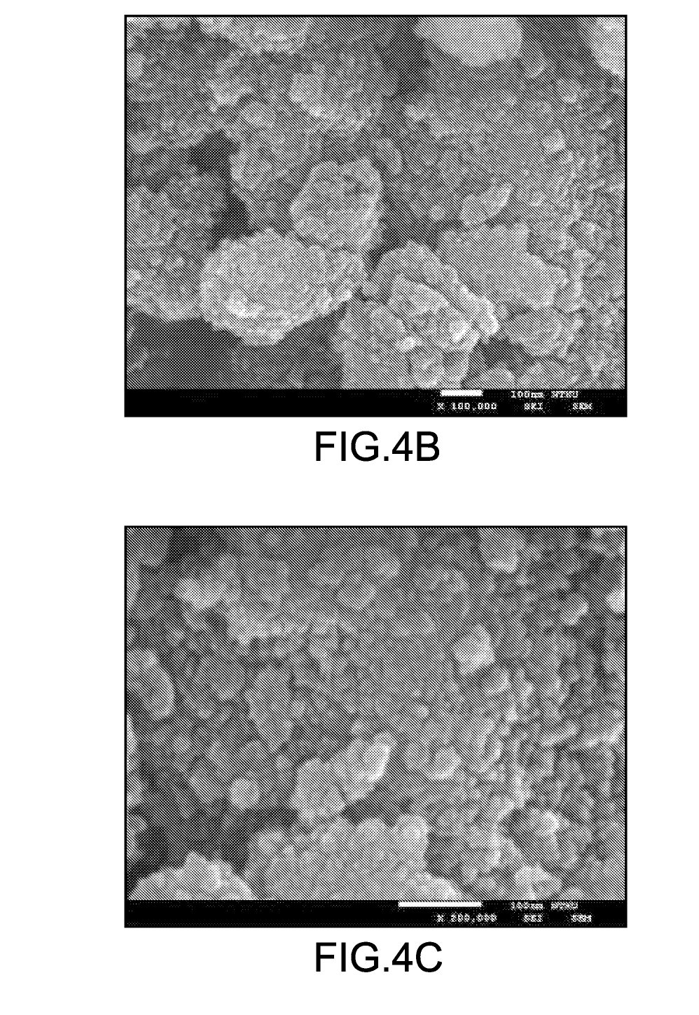

With reference to FIGS. 4A to 4C, before aggregation, the primary particles of the mixing slurries in Examples 1, 2 and 5 were further observed by a scanning electron microscope. Before performing the subsequent steps, the mixing slurry in Example 1 had primary particle sizes ranging from 172 nanometers to 10.09 micrometers, the mixing slurry in Example 2 had primary particle sizes ranging from 445 nanometers to 10.09 micrometers, the mixing slurry in Example 3 had primary particle sizes ranging from 584 nanometers to 17.37 micrometers, the mixing slurry in Example 4 had primary particle sizes ranging from 2970 nanometers to 22.79 micrometers, and the mixing slurry in Example 5 had primary particle sizes ranging from 1729 nanometers to 29.90 micrometers.

The mixing slurry was further treated by filter-pressing separation to separate the mixing slurry into a solid mixture and a liquid mixture. The liquid mixture contained said coolant and aqueous cutting fluid, and the solid mixture contained silicon granules and a few diamond shreds, copper granules, iron granules and nickel granules or their oxides.

In order to prevent the coolant and/or aqueous cutting fluid from reducing the purity, quality, and application performance of the silicon material, the solid mixture was further washed with an aqueous solution to remove the undesired coolant and/or aqueous cutting fluid.

Subsequently, the solid mixture was washed with sulfuric acid to remove the iron granules, copper granules and other metal oxides and alloy oxides soluble in sulfuric acid. Multiple water-washing steps were optionally performed to remove other undesired impurities, and then a silicon material was obtained. Accordingly, the purity of silicon material in accordance with the present invention can be largely improved by these washing steps, thereby improving the electrical quality of a lithium-ion battery containing the silicon material

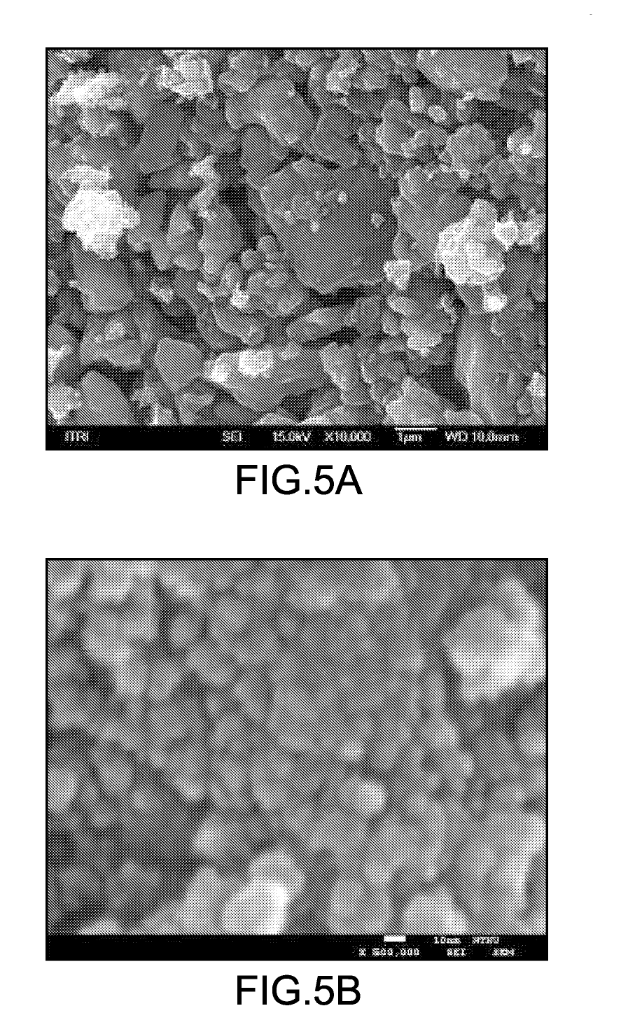

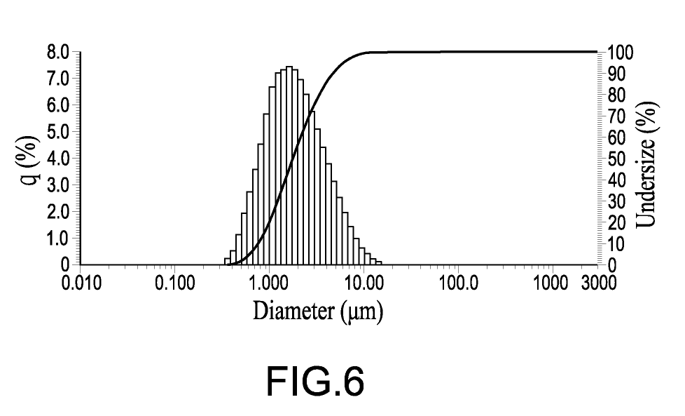

Finally, the silicon material was dried at 100° C. to remove the remaining coolant from the surface of silicon granules to obtain a powdered silicon material. With reference to FIGS. 5A and 5B, before aggregation, the powdered silicon material had primary particle sizes ranging from 5 nanometers to 10 micrometers. With reference to FIG. 6, after a part of the silicon granules aggregated, the powdered silicon material had secondary particle sizes ranging from 250 nanometers to 15 micrometers.

The powdered silicon material was further analyzed by optical emission spectral analysis with inductively coupled plasma spectroscopy, ICP-OES spectroscopy, and the result demonstrated that the iron content and nickel content remaining in the powdered silicon material were both less than 5 ppm. Accordingly, the silicon material produced by the method in accordance with the present invention has a purity of silicon about 99%.

### Example 6

### Producing a Lithium-Ion Battery Comprising a Silicon Material

0.8 grams of powdered silicon material, which was produced by the methods of Example 2, were mixed with 0.2 grams of carbonaceous material (Super-P) and 0.2 grams of butyl benzene rubber to form a slurry for an anode electrode of a lithium-ion battery.

Next, the slurry was spin coated onto a copper foil and then dried, thus producing an anode electrode of a lithium-ion battery. A lithium foil was provided as a reference electrode, also called relative negative electrode, and the reference electrode could be optionally coated with an positive electrode active material, such as LiCoO₂.

Subsequently, the produced anode electrode was disposed opposite to the reference electrode. A separator membrane was placed between the anode electrode and the reference electrode, and the anode electrode, the reference electrode, and the separator were impregnated in an electrolyte with 1M of ethylene carbonate/diethyl carbonate electrolyte with LiPF₆, to produce a lithium-ion battery.

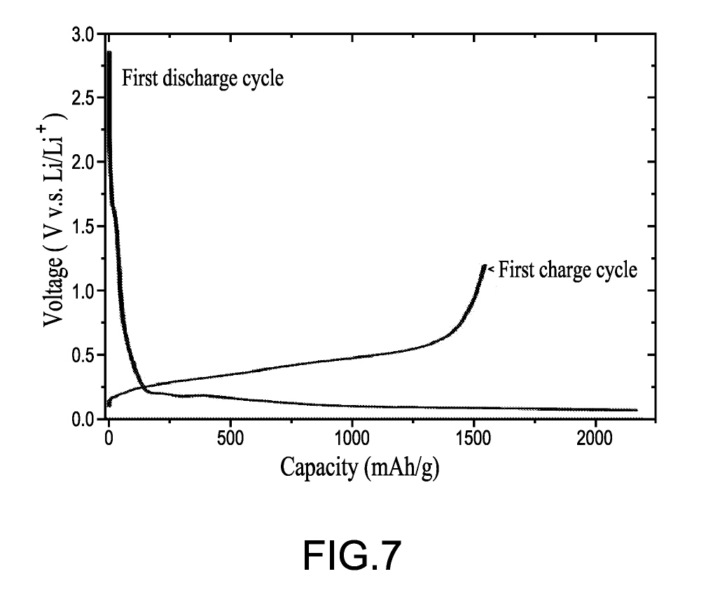

The produced lithium-ion battery was tested by a channel charge/discharge tester with a charge/discharge rate at 0.2 C and a cutoff voltage from 0V to 1.5V. With reference to FIG. 7, the lithium-ion battery had a discharge capacity about 1546 mAh/g on first discharge and a charge capacity about 2168 mAh/g on a first charge.

The results proved that the silicon material produced by the method in accordance with the present invention is suitable as a main component of an anode material in a lithium-ion battery and provides the lithium-ion battery with required charge and discharge capability.

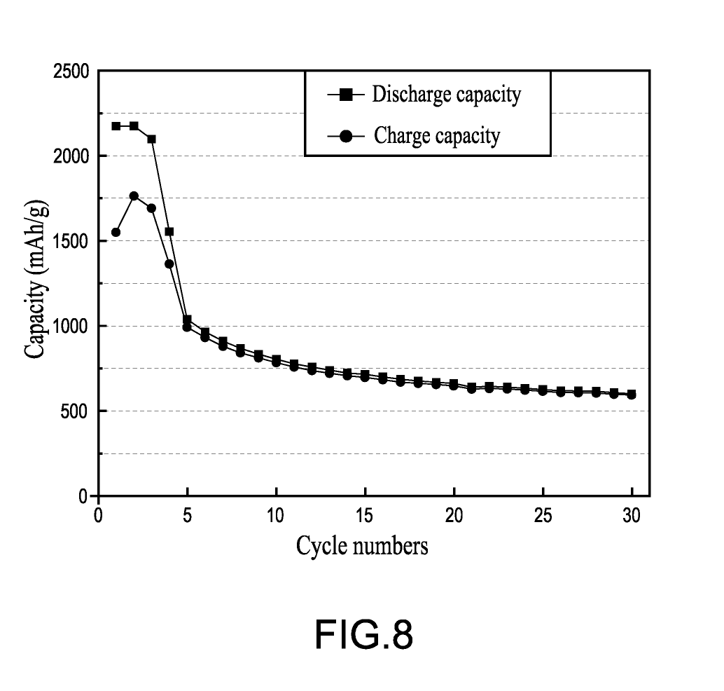

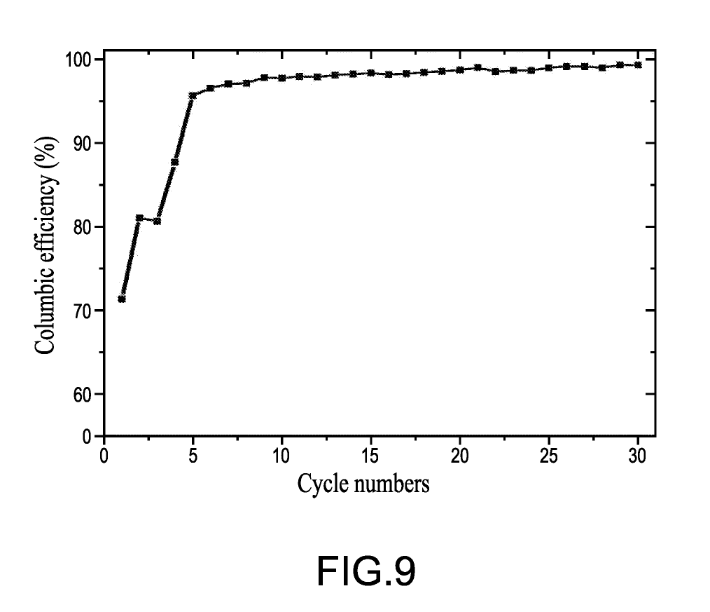

With reference to FIG. 8, the lithium-ion battery of the present invention was further repeatedly tested for 30 charge/discharge cycles at a charge/discharge rate of 0.2 C. The lithium-ion battery still had a capacity about 594 mAh/g and maintained its stability after 30 cycles. Furthermore, FIG. 9 showed that the lithium-ion battery of the present invention still had a columbic efficiency approximating 100% after 100 cycles.

Accordingly, the present invention successfully provides a mass production method of silicon material for a lithium-ion battery to reduce its production cost. Moreover, with the characteristics of high purity and fine granules, the extreme volumetric expansion under heat can be largely reduced, thus enhancing the cycle stability, electrical performance, and quality of a lithium-ion battery containing the silicon material.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of producing a silicon material, comprising the steps of:
providing a wire sawing tool comprising a cutting wire, a base layer disposed on the cutting wire, and multiple abrasives partially embedded into the base layer and having particle sizes ranging from 1 micrometer to 100 micrometers;
slicing a silicon substrate with the wire sawing tool to obtain a mixing slurry; and
treating the mixing slurry by solid-liquid separation, so as to isolate the silicon material from the mixing slurry.

2. The method as claimed in claim 1, wherein the cutting wire has a diameter ranging from 80 micrometers to 500 micrometers

3. The method as claimed in claim 1, wherein the abrasives have particle sizes ranging from 1 micrometer to 50 micrometers.

4. The method as claimed in claim 1, wherein the step of treating the mixing slurry by solid-liquid separation comprises:
separating the mixing slurry into a liquid mixture and a solid mixture by solid-liquid separation;
washing the solid mixture with an aqueous solution to form a washed mixture; and
treating the washed mixture by solid-liquid separation, so as to isolate the silicon material from the washed mixture.

5. The method as claimed in claim 1, wherein the cutting wire is made of iron, copper, nickel or their combinations.

6. The method as claimed in claim 5, wherein the step of treating the mixing slurry by solid-liquid separation comprises:
separating the mixing slurry into a liquid mixture and a solid mixture by solid-liquid separation;
washing the solid mixture with an acidic solution to remove iron, copper, nickel or their combinations, so as to form a purified mixture; and
treating the purified mixture by solid-liquid separation, so as to isolate the silicon material from the purified mixture.

7. The method as claimed in claim 5, wherein the step of treating the mixing slurry by solid-liquid separation comprises:
separating the mixing slurry into a liquid mixture and a solid mixture by solid-liquid separation; and
removing iron, nickel or their combinations from the solid mixture by magnetic separation, so as to obtain the silicon material.

8. The method as claimed in claim 5, wherein the step of treating the mixing slurry by solid-liquid separation comprises:
removing iron, nickel or their combinations from the mixing slurry by magnetic separation to form a collected mixture; and
treating the collected mixture by solid-liquid separation, so as to isolate the silicon material from the collected mixture

9. The method as claimed in claim 1, wherein the method further comprises drying the silicon material to obtain a powdered silicon material.

10. The method as claimed in claim 9, wherein the silicon material is dried at a temperature ranging from 80° C. to 120° C.

11. The method as claimed in claim 1, wherein the silicon material has particle sizes ranging from 5 nanometers to 10 micrometers.

12. The method as claimed in claim 1, wherein the silicon material comprises silicon granules and abrasive granules, and an amount of the silicon granules is not less than 95 wt % based on a total weight of the silicon material.

13. The method as claimed in claim 1, wherein the abrasives are made of material from the group consisting of: diamond, diamond-like carbon, silicon carbide, boron carbide, aluminum nitride, zirconium dioxide and their combinations

14. The method as claimed in claim 1, wherein the base layer is made of resin, metal, or metal alloy.

15. The method as claimed in claim 1, wherein the silicon substrate includes a single crystal silicon substrate, a polycrystalline silicon substrate or an amorphous silicon substrate.

16. The method as claimed in claim 1, wherein the solid-liquid separation includes centrifuge separation, filter-pressing separation, sedimentation, membrane filtration, or decantation separation

17. An anode material of a lithium-ion battery, comprising a silicon material produced by the method as claimed in claim 1, the silicon material having particle sizes ranging from 5 nanometers to 10 micrometers.

18. The anode material as claimed in claim 17, wherein the silicon material comprises silicon granules and abrasive granules, and an amount of the silicon granules is not less than 95 wt % based on a total weight of the silicon material.

19. The anode material as claimed in claim 18, wherein the silicon material has particle sizes ranging from 5 nanometers to 2 micrometers.

20. A method of producing an anode electrode of a lithium-ion battery, comprising the steps of:
preparing a silicon material produced by the method as claimed in claim 1, the silicon material having particle sizes ranging from 5 nanometers to 10 micrometers;
mixing the silicon material with a carbonaceous material to form a slurry; and
coating the slurry on a metal substrate and drying the slurry, so as to produce the anode electrode of the lithium-ion battery.

21. The method as claimed in claim 20, wherein the step of preparing a silicon material comprises:
providing a wire sawing tool comprising a cutting wire, a base layer disposed on the cutting wire, and multiple abrasives partially embedded onto the base layer and having particle sizes ranging from 1 micrometer to 50 micrometers;
slicing a silicon substrate with the wire sawing tool to obtain a mixing slurry; and
treating the mixing slurry by solid-liquid separation, so as to isolate the silicon material from the mixing slurry.
